(19) United States
(12) Patent Application Publication
(10) Pub. No.: US 2013/0060754 A1
(43) Pub. Date: Mar. 7, 2013

(54) Feature Search Request Management

(71) Applicants: Luca Lazzaro, Naples (IT); Alessandro Scotti, Rome (IT)

(72) Inventors: Luca Lazzaro, Naples (IT); Alessandro Scotti, Rome (IT)

(73) Assignee: INTERNATIONAL BUSINESS MACHINES CORPORATION, Armonk, NY (US)

(21) Appl. No.: 13/224,073

(22) Filed: Sep. 1, 2011

(51) Int. Cl. G06F 17/30

(52) U.S. Cl. 707/722; 707/758; 707/E17.005; 707/E17.014

(57) ABSTRACT

The different illustrative embodiments provide a method, a computer program, and an apparatus for managing a search request. Responsive to receiving the search request comprising a task to be performed, a number of applications that is configured to perform the task is identified. A determination is made whether an application in the number of applications is configured to receive a parameter to perform the task that is absent from the search request. Responsive to a determination that the application in the number of applications is configured to receive the parameter to perform the task that is absent from the search request, a request for the parameter is presented. The number of applications that is configured to perform the task is presented

### BACKGROUND

1. Field

The disclosure relates generally to an improved data processing system and more specifically to an improved data processing system for processing search requests. Even more specifically, the disclosure relates to a method, computer program product, and apparatus for managing a search request.

2. Description of the Related Art

Search engines are commonly used to locate information stored in computer networks. A search engine is an application running on a number of computer systems that identifies pages known to the search engine as containing one or more terms in a search query. One commonly used search engine on the Internet is Google by Google Inc. in Mountain View, Calif.

A search query is a collection of one or more words that describes a topic about which a user desires to locate information. For example, assume that a user desires to locate documents on the Internet about George Washington. Such a search query may be “George Washington.” However, in some illustrative examples, a user desires more specific information about a particular topic. In such an illustrative example, the user may change or add words to the search query. For example, assuming the user desires to locate information on the Internet about the years of George Washington as President of the United States, the user may use “George Washington presidency” or “George Washington president years” as a search query.

The user may connect to a search engine in order to submit a search query using an application running on a client computer. For example, the application may be a Web browser when the search engine may be reached on the World Wide Web. The World Wide Web is a collection of computers connected by a network that communicate using a particular protocol. For example, the computers may communicate using Hypertext Transfer Protocol (HTTP).

Once the user connects to the search engine, the user may submit a search query. The search engine then locates documents that contain one or more terms in the search query. For example, a search for “George Washington” may result in documents that contain “George” or “Washington.” However, a page that does not mention either word would not be contained in the results of the search. The search engine may present the results of the search query as a list of links to documents. The user may then select one or more documents to view.

In some illustrative examples, a user desires to run an application on the computer system being used by the user. The user may desire to open a document or perform another function with the application. In such an illustrative example, the user locates the application and runs the application. Then, the user indicates to the application on which file or function the user desires to operate.

### SUMMARY

The different illustrative embodiments provide a method, a computer program, and an apparatus for managing a search request. Responsive to receiving the search request comprising a task to be performed, a number of applications that is configured to perform the task is identified. A determination is made whether an application in the number of applications is configured to receive a parameter to perform the task that is absent from the search request. Responsive to a determination that the application in the number of applications is configured to receive the parameter to perform the task that is absent from the search request, a request for the parameter is presented. The number of applications that is configured to perform the task is presented.

### BRIEF DESCRIPTION OF THE SEVERAL VIEWS OF THE DRAWINGS

FIG. 1 depicts an illustrative diagram of a data processing environment in which illustrative embodiments may be implemented;

FIG. 2 depicts a diagram of a data processing system in accordance with an illustrative embodiment;

FIG. 3 depicts an illustration of a search management environment in accordance with an illustrative embodiment;

FIG. 4 depicts an illustration of search results in accordance with an illustrative embodiment;

FIG. 5 depicts an additional illustration of search results in accordance with an illustrative embodiment;

FIG. 6 depicts an illustration of configuration information in accordance with an illustrative embodiment;

FIG. 7 depicts an illustration of a flowchart of a process for managing a search request in accordance with an illustrative embodiment;

FIG. 8 depicts an illustration of a flowchart of a process for adding an application to a registry in accordance with an illustrative embodiment; and

FIG. 9 depicts an illustration of a flowchart of a process for processing a search query in accordance with an illustrative embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

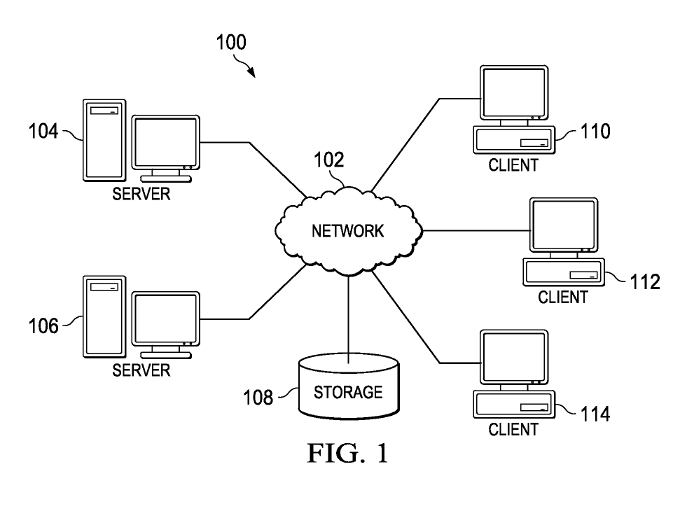

With reference now to the figures and, in particular, with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and other devices not shown.

Server computer 104 and/or server computer 106 store image files or have access to image files stored in storage unit 108 in these illustrative examples. Client computers 110, 112, and 114 may request image files from server computer 104 and/or server computer 106. Such image files may be made accessible on a website using a web server process running on server computer 104 and/or server computer 106. Alternatively, server computer 104 and/or server computer 106 may make the image files accessible to client computers 110, 112, and 114 using a social network server process.

Program code located in network data processing system 100 may be stored on a computer recordable storage medium and downloaded to a data processing system or other device for use. For example, program code may be stored on a computer recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

In these illustrative examples, client computer 110 generates a search request and sends the search request to server computer 104 using network 102. The search request may include a task to be performed. Server computer 104 receives the search request and identifies applications in a registry that are configured to perform the task. In the event that an application uses a parameter to perform the task that is not present in the search request, server computer 104 sends a request for the parameter to client computer 110. Client computer 110 presents the request and receives the parameter. Client computer 110 sends the parameter to server computer 104. Server computer 104 then performs the search and returns results to client computer 110.

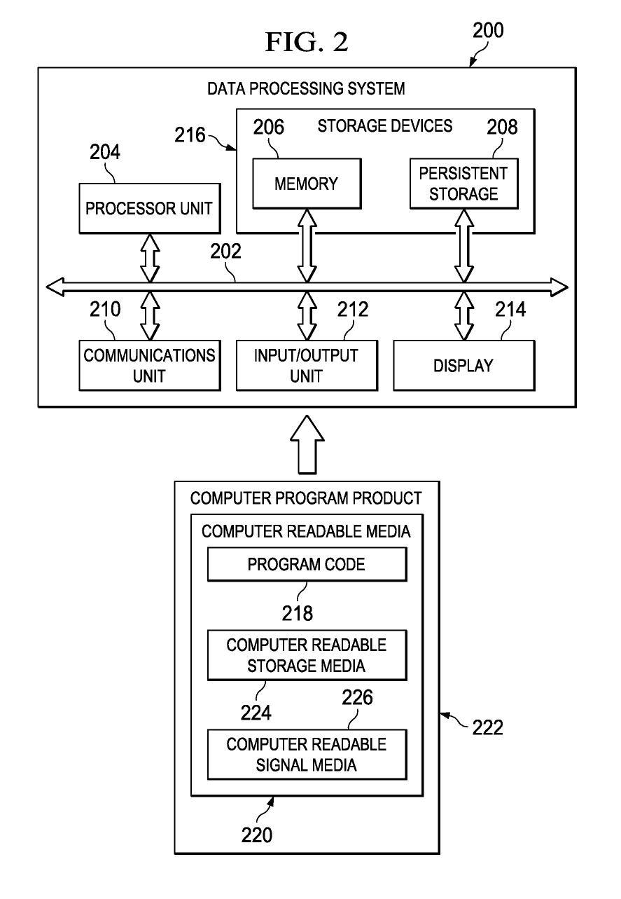

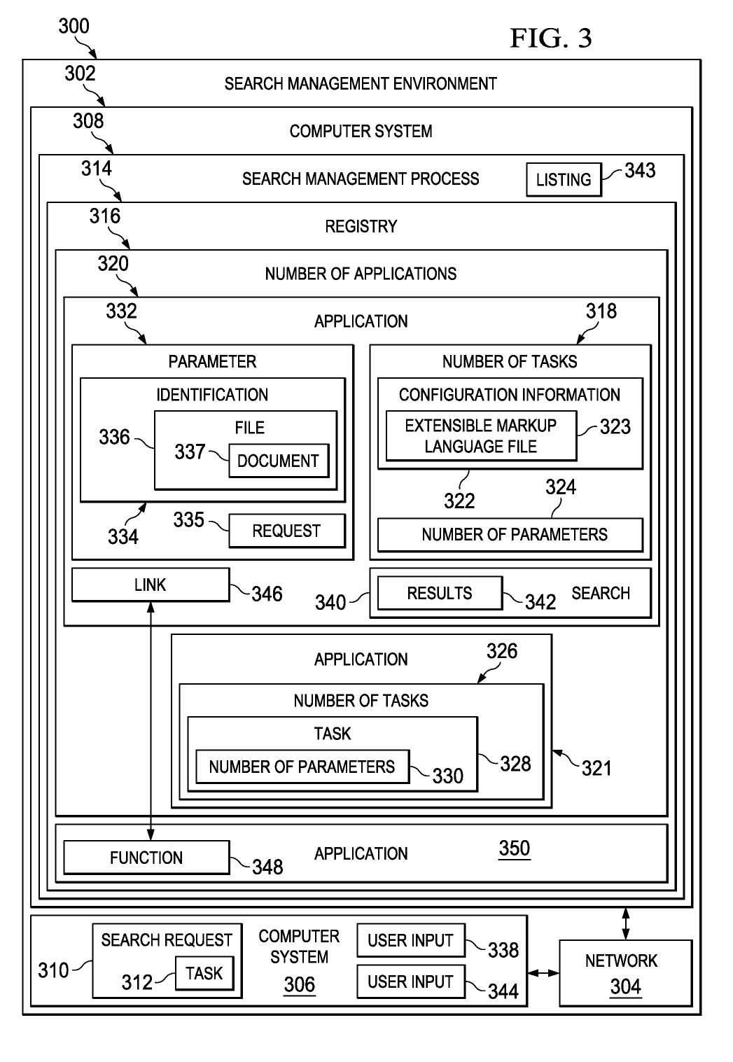

Turning now to FIG. 2, a diagram of a data processing system is depicted in accordance with an illustrative embodiment. In this illustrative example, data processing system 200 includes communications fabric 202, which provides communications between processor unit 204, memory 206, persistent storage 208, communications unit 210, input/output (I/O) unit 212, and display 214. Data processing system 200 is an example of a data processing system that can be used to implement server computers and client computers in network data processing system 100 in FIG. 1. More specifically, in one illustrative example, data processing system 200 may run a search request management process, such as search management process 308 in FIG. 3.

Processor unit 204 serves to process instructions for software that may be loaded into memory 206. Processor unit 204 may be a number of processors, may be a multi-processor core, or some other type of processor, depending on the particular implementation. A “number”, as used herein, with reference to an item, means “one or more items”. Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs may be located in storage devices 216, which are in communication with processor unit 204 through communications fabric 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and processed by a processor in processor unit 204. The program code in the different embodiments may be embodied on different physical or computer readable storage media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be computer readable storage media 224 or computer readable signal media 226. Computer readable storage media 224 may include, for example, an optical or magnetic disc that is inserted or placed into a drive or other device that is part of persistent storage 208 for transfer onto a storage device, such as a hard drive that is part of persistent storage 208. Computer readable storage media 224 also may take the form of a persistent storage, such as a hard drive, a thumb drive, or a flash memory that is connected to data processing system 200. In some instances, computer readable storage media 224 may not be removable from data processing system 200. In these illustrative examples, computer readable storage media 224 is a non-transitory computer readable storage media.

Alternatively, program code 218 may be transferred to data processing system 200 using computer readable signal media 226. Computer readable signal media 226 may be, for example, a propagated data signal containing program code 218. For example, computer readable signal media 226 may be an electro-magnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer readable signal media 226 for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code. As one example, the data processing system may include organic components integrated with inorganic components, and/or may be comprised entirely of organic components, excluding a human being. For example, a storage device may be comprised of an organic semiconductor.

As another example, a storage device in data processing system 200 is any hardware apparatus that may store data. Memory 206, persistent storage 208 and computer readable media 220 are examples of storage devices in a tangible form. In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub that may be present in communications fabric 202.

The different illustrative embodiments recognize and take into account a number of different considerations. For example, the different illustrative embodiments recognize and take into account that a user may be unaware of a particular application that is configured to perform a task the user desires to perform. For example, the user may desire to open a document of a particular type. The user may know the file to be opened, but not the application that opens such a document.

The different illustrative embodiments further recognize and take into account that even when the user knows the application configured to perform a task, the application may be activated only by navigating a number of menus that may be confusing to the user. Additionally, the application may use one or more parameters to perform the task. For example, a word processing application may only open a particular document for editing when the document is specified. The different illustrative embodiments present the user with a request for the absent parameters in a search request. The request may include recently and/or frequently used values for the parameters to suggest values that the user may desire to use.

Thus, the different illustrative embodiments provide a method, a computer program, and an apparatus for managing a search request. Responsive to receiving the search request comprising a task to be performed, a number of applications that is configured to perform the task is identified. A determination is made whether an application in the number of applications is configured to receive a parameter to perform the task that is absent from the search request. Responsive to a determination that the application in the number of applications is configured to receive the parameter to perform the task that is absent from the search request, a request for the parameter is presented. The number of applications that are configured to perform the task is presented

Turning now to FIG. 3, an illustration of a search management environment is depicted in accordance with an illustrative embodiment. Search management environment 300 is an example of an environment in which illustrative embodiments may be implemented.

Search management environment 300 contains computer system 302, network 304, and computer system 306. Network 304 is an example of network 102 in FIG. 1. Computer system 302 is an example of server computer 104, and computer system 306 is an example of client computer 110 in FIG. 1. Computer system 304 and computer system 302 communicate using network 304 in this illustrative embodiment. For example, network 304 may be a transmission control protocol/Internet protocol (TCP/IP) network.

In this illustrative example, computer system 306 connects to search management process 308 using network 304 to request that a search be performed by search management process 308. In response to a user entering a search query, computer system 306 generates search request 310. Search request 310 includes a number of search terms. When used with reference to a number of means one or more items. For example, a number of search terms is one or more search terms.

Search terms are words about which the user causing search request 310 to be generated desires to locate information. For example, a search term may be “George Washington.” In this illustrative embodiment, search request 310 includes task 312. Task 312 is a number of words indicating the function that the user desires to perform. For example, task 312 may be “open document,” “create event,” “edit document test.doc,” or another suitable phrase.

Computer system 306 transmits search request 310 to search management process 308 running on computer system 302 using network 304. Search management process 308 is run by computer system 302 using a processor unit, such as processor unit 204 in FIG. 2. Program instructions associated with search management process 308 may be stored in storage devices 216 in FIG. 2. Search management process 308 running on computer system 302 receives search request 310 using network 304.

Search management process 308 connects to registry 314. Registry 314 may be stored at least partially on computer system 302, or on another computer system accessible to computer system 302 using network 304. Registry 314 is a collection of information about applications that are accessible to computer system 306. Such applications may be run and/or stored on computer system 302, computer system 306, and/or another computer system.

The information in registry 314 may include information about the tasks that may be performed by an application about which information is stored in registry 314. In one illustrative example, application 321 is an application about which information is stored in registry 314. In the illustrative example, application 321 may be a spreadsheet application that is configured to perform the task of opening a spreadsheet document. In such an illustrative example, registry 314 contains the names of number of tasks 326 that application 321 is configured to perform. For task 328 in number of tasks 326, registry 314 may also include information about number of parameters 330 used by application 321 to perform task 328. For example, number of parameters 330 includes a name and/or type of document which to open, whether to open the document in read only mode, a template to use when creating a new document, and/or another suitable parameter. In some illustrative embodiments, number of parameters 330 includes multiple parameters.

Applications are added to registry 314 to allow search management process 308 to present the applications that perform task 312 in search request 310. Application 320 is an application about which information is to be stored in registry 314. In one illustrative example, search management process 308 or another process adds application 320 to registry 314 by identifying configuration information 322. Configuration information 322 is information about the tasks application 320 is configured to perform and the parameters used by application 320 to perform the tasks. In these illustrative examples, configuration information 322 includes number of tasks 318 and number of parameters 324 for each task in number of tasks 318. Configuration information 322 is Extensible Markup Language (XML) file 323 in some illustrative embodiments. For example, a task in number of tasks 318 may be “open word processing document.” Number of parameters 324 for such a task may include the name or type of document which to open, whether to open the document in read only mode, a template to use when creating a new document, or another suitable parameter.

Once search request 310 is received by search management process 308, search management process 308 identifies number of applications 316 in registry 314. Number of applications 316 is a collection of applications that is configured to perform task 312 in search request 310. For example, task 312 in search request 310 may be “open word processing document.” In such an illustrative example, number of applications 316 includes the collection of applications in registry 314 that are configured to open a word processing document. In some illustrative embodiments, search management process 308 uses information contained in registry 314 to identify number of applications 316 that performs task 312. In other illustrative embodiments, search management process 308 identifies number of applications 316 using configuration information 322.

In this illustrative example, number of applications 316 includes application 320 and application 321. After search management process 308 identifies number of applications 316, search management process 308 determines whether each application is configured to receive at least one parameter to perform task 312. In this illustrative embodiment, application 320 is configured to receive parameter 332 to perform task 312. For example, parameter 332 may be identification 334 of file 336 on which to perform an operation. In some illustrative embodiments, file 336 is document 337. Document 337 is a collection of data that forms a particular file or data store. For example, document 337 may be an image file containing data that forms a photo of a house when displayed as an image.

When search management process 308 determines that number of applications 320 is configured to receive parameter 332, search management process 308 determines whether parameter 332 is present in search request 310. For example, search request 310 may include “open document test.doc.” In such an illustrative example, search management process 308 determines that search request 310 includes task 312 of “open document” and parameter 332 of “test.doc.” In the event that search request 310 does not include parameter 332, search management process 308 generates request 335 for user input 338. Request 335 may be sent to computer system 302 and presented by computer system 302. Request 335 for user input 338 may be in the form of a drop down user interface element that presents a name for the absent parameter. For example, the request for user input 338 may include “open document <name>.” In such an illustrative embodiment, the user may send user input 338 that includes the name of the document to open. In another illustrative embodiment, search management process 308 presents a collection of frequently and/or recently used values for parameter 332. Of course, the request for user input 338 may include more than one task and/or more than one parameter.

Registry 314 may indicate that application 320 in number of applications 316 is configured to perform a search using search request 310. For example, application 320 may be configured to access a number of files in performing number of tasks 318. In one illustrative example, application 320 is a database management application. Search management process 308 may provide at least a portion of search request 310 to the database management application. The database management application may then search a database for tables or values that match search request 310. For example, search request 310 may include “search quantity >10.” In such an illustrative example search management process 308 identifies application 320 as performing the task “search quantity” in registry 314. Search management process 308 then provides “>10” to application 320. In one illustrative embodiment, search management process 308 uses an application programming interface (API) described in registry 314 and/or configuration information 322 to provide “>10” to application 320. Application 320 uses search request 310 to perform search 340. Application 320 returns results 342 to search management process 308.

Search management process 308 then causes number of applications 316 to be presented by computer system 306. Presenting an item, as used herein, includes displaying the item using a display device and/or audibly reading the item using a text-to-speech algorithm and an audio output device accessible to computer system 306. In these illustrative examples, search management process 308 returns results for search request 310 to computer system 306 using network 304. Computer system 306 then displays the results using a display device, such as display 214 in FIG. 2.

Search management process 308 returns the results of search request 310 as listing 343 of tasks and/or applications in this illustrative embodiment. After returning the results of search request 310 to computer system 306, search management process 308 receives user input 344. In these illustrative examples, computer system 306 requests user input 344 by presenting a collection of links to each task performed by number of applications 316 that was included in the results of search request 310. For example, computer system 306 may receive user input 344 in the form of a user activating application 320. Application 320 may be link 346 in some illustrative embodiments. In such illustrative embodiments, link 346 is a call to function 348 associated with application 350. Function 348 is a process associated with application 350. For example, function 348 may be program code that causes computer system 302 to open a document file and perform an action on the document file. In another illustrative embodiment, activating application 320 in the results causes computer system 306 to open a Web browsing application and navigate to an address provided by application 320.

The illustration of search management environment 300 is not meant to imply physical or architectural limitations to the manner in which different features may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

For example, when a user activates application 320, application 320 may be stored and/or run on computer system 302, computer system 306, or another suitable computer system. In another illustrative embodiment, request 335 is presented in the form of receiving audio input for speech-to-text. In other words, the user may speak user input 338. In yet other illustrative embodiments, parameter 332 may be provided in the form of a file sent from computer system 306. In other words, parameter 332 may be transferred from computer system 306 to search management process 308 in the form of an uploaded file.

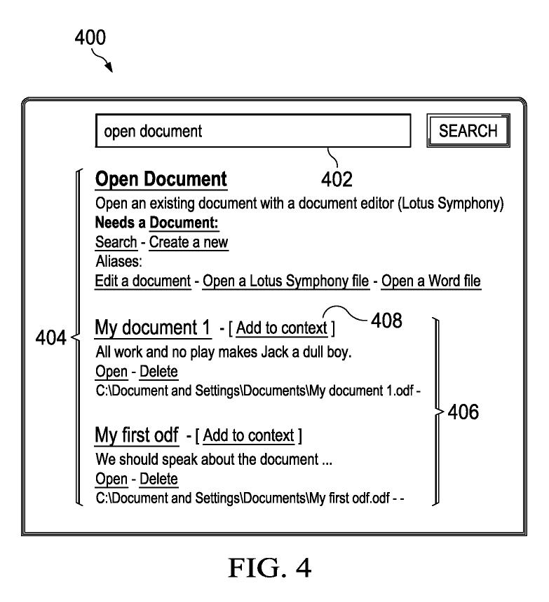

Looking now to FIG. 4, an illustration of search results is depicted in accordance with an illustrative embodiment. Search results 400 are presented by a computer system, such as computer system 302 in FIG. 3, as a result of processing a search request, such as search request 310 in FIG. 3.

Search results 400 includes search query 402. Search query 402 includes a task to be performed in this illustrative example, such as task 312 in FIG. 3. Search query 402 represents that “open document” is the task to be performed. Results 404 are the number of applications, such as number of applications 316 in FIG. 3, that is configured to perform the task in search query 402.

Results 404 also include documents 406. Documents 406 are the results of a search performed by an application in the number of applications, such as search 340 in FIG. 3. In this illustrative example, activating a document in documents 406 causes the application associated with the document to open the document. Activating link 408 causes the document name to be added to the search query and the search is performed again with the modified search query.

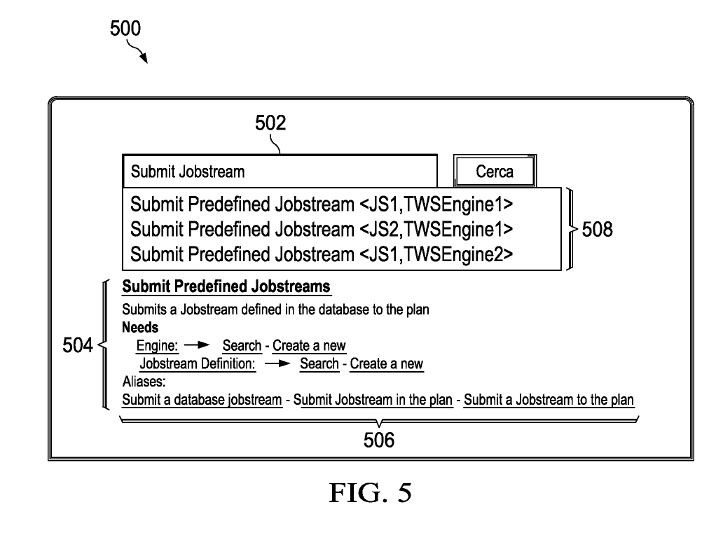

Turning now to FIG. 5, an additional illustration of search results is depicted in accordance with an illustrative embodiment. Search results 500 are presented by a computer system, such as computer system 302 in FIG. 3, as a result of processing a search request, such as search request 310 in FIG. 3.

Search results 500 include search query 502 and results 504. Search query 502 includes the search terms used to generate results 504. Results 504 includes the application that is configured to perform the task requested in search query 502. In this illustrative example, the task performed by the application that matches search query 502 is displayed. Results 504 also includes aliases 506. Aliases 506 are alternative names for the task that is performed by the application and requested in search query 502.

In this illustrative embodiment, the application that performs the task “submit predefined jobstreams” uses two parameters to perform the task. A search management process determined that the parameters were absent from search query 502. Thus, the search management process requests the parameters from the user. In this illustrative example, suggestions 508 indicate frequently and/or recently used options for the two parameters in the form of an autocomplete element. Of course, suggestions 508 may also be identified as results of a search by the application, such as results 342 of search 340 by application 320 in FIG. 3.

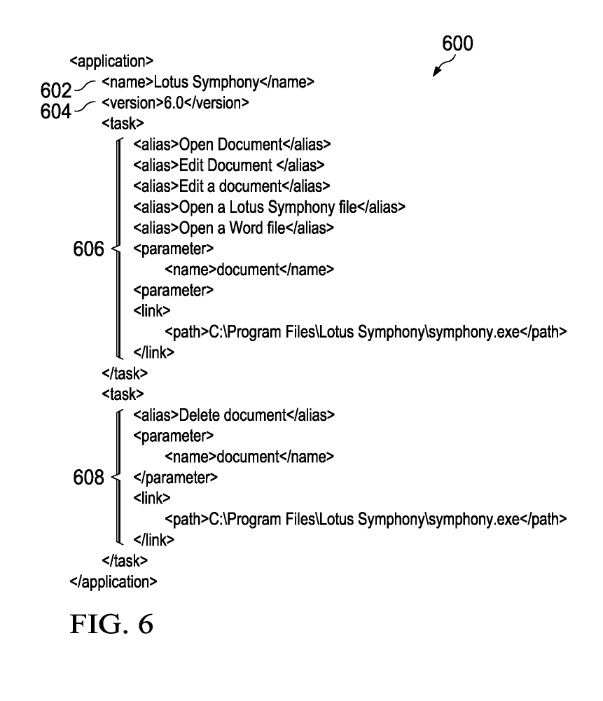

With reference now to FIG. 6, an illustration of configuration information is depicted in accordance with an illustrative embodiment. Configuration information 600 is an example implementation of configuration information 322 in FIG. 3.

Configuration information 600 is in the form of an Extensible Markup Language (XML) file in this illustrative embodiment. Configuration information 600 describes some exemplary tasks and parameters used by an application “Lotus Symphony.” Configuration information 600 may contain information about the application that was included in search results 400 in FIG. 4 for “open a document.”

Configuration information 600 includes name 602 of the application and version 604 of the application. Configuration information 600 also includes information about task 606 and task 608. Task 606 includes multiple aliases in this illustrative example. For example, task 606 may be identified in a search query as “Open Document” or “Open a Word file.”

Task 606 further includes a parameter used by the application to perform task 606. In this illustrative embodiment, a parameter having the name “document” is used to perform task 606. Task 606 also includes a link to the path of the file in a file system that is to be run in the event that task 606 is activated in search results, such as search results 400 in FIG. 4. Task 608 includes an alias, a parameter and a link to the file to execute in the event task 608 is activated in search results. In some illustrative embodiments, a parameter may be passed to the application or an application programming interface call may be generated to activate the application to perform the requested task.

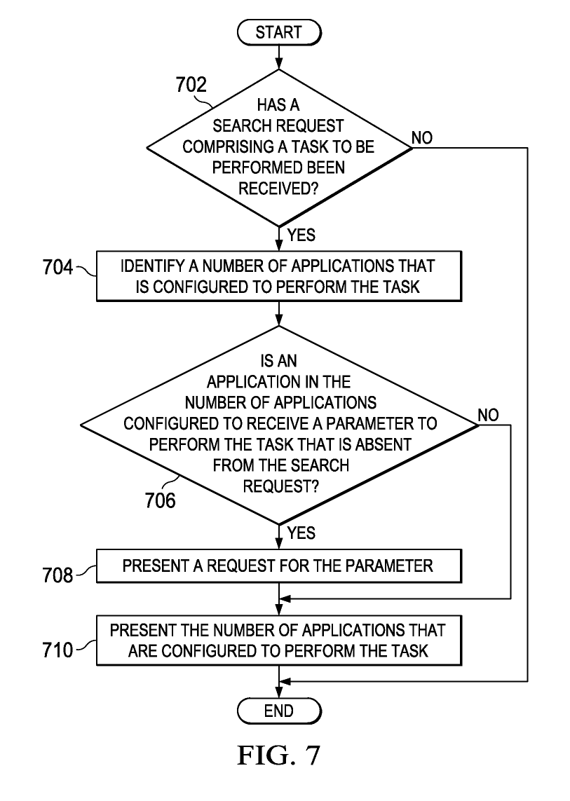

Turning now to FIG. 7, an illustration of a flowchart of a process for managing a search request is depicted in accordance with an illustrative embodiment. The process may be performed by search management process 308 running on computer system 302 in FIG. 3.

The process begins by determining whether a search request comprising a task to be performed has been received (step 702). The search request is an example of search request 310 in FIG. 3. The search request may include search terms representing a task to be performed. If the process determines that the search request comprising the task to be performed has not been received, the process terminates. Of course, in other illustrative embodiments, the process may repeat step 702 until such a search request is received.

If the process determines that the search request comprising the task to be performed has been received at step 702, the process identifies a number of applications that is configured to perform the task (step 704). The number of applications may be identified using information in a registry of applications. The process then determines whether an application in the number of applications is configured to receive a parameter to perform the task that is absent from the search request (step 706). The parameter is an example of parameter 332 in FIG. 3. The parameter for the task to be performed by the application may be described in the registry, such as registry 314 in FIG. 3.

If the process determines that the application in the number of applications is configured to receive a parameter to perform the task that is absent from the search request, the process presents a request for the parameter (step 708). The process may present the request in the form of a dropdown user interface element that identifies the name of the parameter or the process may suggest values for the parameter based on previously entered values. The process may also request a list of possible values from the application. Such a request may include the application performing a search of a data source for possible values. If the process determines that the application in the number of applications is not configured to receive a parameter to perform the task that is absent from the search request at step 706, the process continues to step 710. The process then presents the number of applications that is configured to perform the task (step 710). The process terminates thereafter.

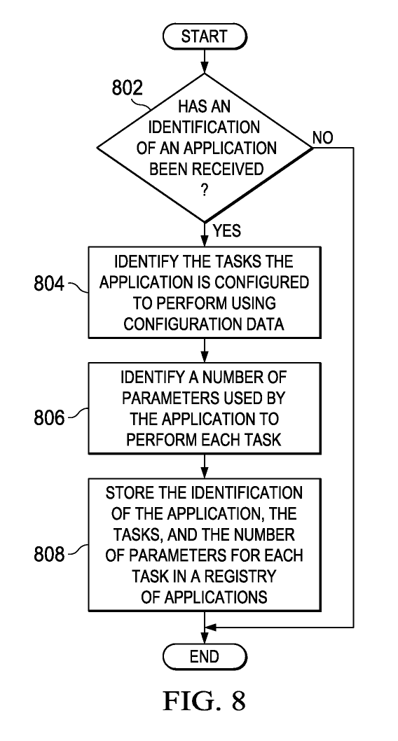

Turning now to FIG. 8, an illustration of a flowchart of a process for adding an application to a registry is depicted in accordance with an illustrative embodiment. The process may be performed by search management process 308 running on computer system 302 in FIG. 3.

The process begins by determining whether an identification of an application has been received (step 802). The identification may be in the form of a request to add a particular application. If the process determines that such an identification has been received, the process identifies the tasks the application is configured to perform using configuration data (step 804). The configuration data may be in the form of an Extensible Markup Language (XML) file in these illustrative examples.

The process then identifies a number of parameters used by the application to perform each task (step 806). The parameters are an example of number of parameters 324 in FIG. 3. The process then stores the identification of the application, the tasks, and the number of parameters for each task in a registry of applications (step 808). The process terminates thereafter.

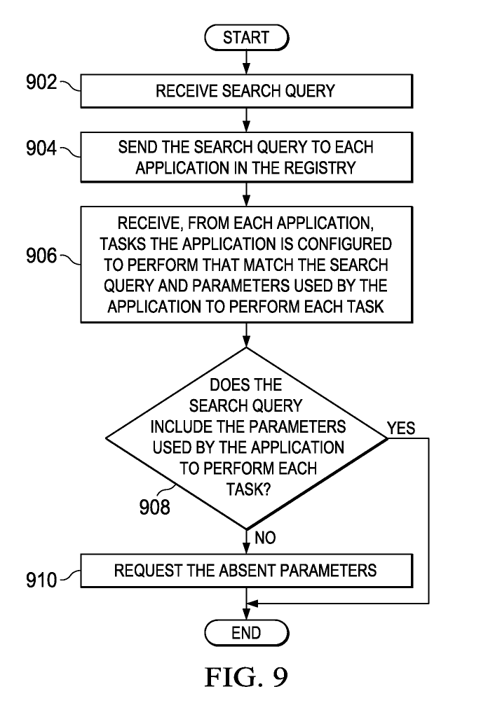

With reference now to FIG. 9, an illustration of a flowchart of a process for processing a search query is depicted in accordance with an illustrative embodiment. The process may be performed by search management process 308 running on computer system 302 in FIG. 3.

The process begins by receiving a search query (step 902). The search query is an example of search request 310 in FIG. 3. The process then sends the search query to each application in the registry (step 904). The process may send the search query to the applications using an application programming interface (API), a network request, or another suitable process. In some illustrative embodiments, the process only sends the search query to applications that are identified as having a search process in the registry and are configured to perform the task in the search query according to the registry.

The process then receives, from each application, tasks the application is configured to perform that match the search query and parameters used by the application to perform each task (step 906). The process then determines whether the search query includes the parameters used by the application to perform each task (step 908). The process may identify the task in the search query and identify each phrase separated by a particular character as a parameter in one illustrative embodiment. Of course, the process may use other methods to identify the parameters in the search query. If the process determines that the search query includes the parameters, the process terminates. If the process determines that the search query does not include the parameters, the process requests the absent parameters (step 910).

The flowcharts and block diagrams in the different depicted embodiments illustrate the architecture, functionality, and operation of some possible implementations of apparatus and methods in different advantageous embodiments. In this regard, each block in the flowcharts or block diagrams may represent a module, segment, function, and/or a portion of an operation or step. For example, one or more of the blocks may be implemented as program code, in hardware, or a combination of the program code and hardware. When implemented in hardware, the hardware may, for example, take the form of integrated circuits or field programmable gate arrays that are manufactured or configured to perform one or more operations in the flowcharts or block diagrams.

In some alternative implementations, the function or functions noted in the block may occur out of the order noted in the figures. For example, in some cases, two blocks shown in succession may be processed substantially concurrently, or the blocks may sometimes be processed in the reverse order, depending upon the functionality involved. For example, encryption may be done concurrently or in an order different from the order depicted in the figures. Also, other blocks may be added in addition to the illustrated blocks in a flowchart or block diagram.

The different illustrative embodiments allow a user to enter a task that the user desires to perform, rather than the user navigating through menus to a particular application about which the user knows. The user enters a search request and sees results of a search for documents with the terms in the search request and results of a search for tasks that may be performed by applications accessible to the user. By requesting parameters from the user, the user may use the application without being aware of the particular parameters used by the application to perform the task. Further, the user may be presented with common or frequently used options for the parameters, allowing the user to make sensible selections for the parameters without knowing specifics about the parameters.

Thus, the different illustrative embodiments provide a method, a computer program, and an apparatus for managing a search request. Responsive to receiving the search request comprising a task to be performed, a number of applications that is configured to perform the task is identified. A determination is made whether an application in the number of applications is configured to receive a parameter to perform the task that is absent from the search request. Responsive to a determination that the application in the number of applications is configured to receive the parameter to perform the task that is absent from the search request, a request for the parameter is presented. The number of applications that are configured to perform the task is presented.

The terminology used herein is for the purpose of describing particular embodiments only and is not intended to be limiting of the invention. As used herein, the singular forms “a”, an and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for processing a search request comprising:
responsive to receiving the search request comprising a task to be performed, identifying in a registry a number of applications that is configured to perform the task;
identifying a set of parameters in the search request;
determining whether an application in the number of applications is configured to receive a parameter to perform the task that is absent from the set of parameters identified in the search request;
responsive to a determination that the application in the number of applications is configured to receive the parameter to perform the task that is absent from the search request, presenting a request for the parameter; and
presenting the number of applications that is configured to perform the task.

2. The method of claim 1, wherein the application is a first application and further comprising:
receiving configuration information for a second application comprising a number of tasks that is performed by the second application and a number of parameters for performing each of the number of tasks; and
adding the configuration information for the second application to a registry.

3. The method of claim 2, wherein identifying a number of applications that is configured to perform the task comprises:
determining whether the identification of the second application includes the task to be performed; and
responsive to a determination that the identification of the second application includes the task to be performed, adding the second application to the number of applications.

4. The method of claim 1, wherein presenting the number of applications that is configured to perform the task comprises presenting a listing of the number of applications, and further comprising:
receiving a user input to activate the application in the number of applications; and
responsive to receiving the user input to activate the application in the number of applications, running the application to perform the task.

5. The method of claim 4, wherein the parameter comprises an identification of a file, and wherein running the application to perform the task comprises:
performing, by the application, the task on the file.

6. The method of claim 5, wherein the file is a document, and performing, by the application, the task on the file comprises:
opening the document using the application.

7. The method of claim 1 wherein identifying the number of applications that is configured to perform the task comprises:
identifying a number of tasks configured to be performed by the application in the number of applications using configuration information;
identifying a number of parameters that the application is configured to receive to perform the number of tasks.

8. The method of claim 7, wherein the configuration information comprises an extensible markup language file.

9. The method of claim 4, wherein the application is a first application, and wherein the first application comprises a link to a function in a second application.

10. The method of claim 1 further comprising:
sending the search request to the application for performing a search;
receiving results from the application; and
presenting the results with the number of applications that is configured to perform the task.

11. A computer program product comprising:
a non-transitory computer recordable storage medium;
program instructions, stored on the non-transitory computer recordable storage medium, for identifying in a registry a number of applications that is configured to perform a task responsive to receiving the search request comprising the task to be performed;
program instructions, stored on the non-transitory computer recordable storage medium, for identifying a set of parameters in the search request;
program instructions, stored on the non-transitory computer recordable storage medium, for determining whether an application in the number of applications is configured to receive a parameter to perform the task that is absent from the set of parameters identified in the search request;
program instructions, stored on the non-transitory computer recordable storage medium, for presenting a request for the parameter responsive to a determination that the application in the number of applications is configured to receive the parameter to perform the task that is absent from the search request; and
program instructions, stored on the non-transitory computer recordable storage medium, for presenting the number of applications that is configured to perform the task.

12. The computer program product of claim 11, wherein the program code for identifying the number of applications that is configured to perform the task comprises:
program instructions, stored on the non-transitory computer recordable storage medium, for identifying a number of tasks configured to be performed by the application in the number of applications using configuration information;
program instructions, stored on the non-transitory computer recordable storage medium, for identifying a number of parameters that the application is configured to receive to perform the number of tasks.

13. The computer program product of claim 12, wherein the configuration information comprises an extensible markup language file.

14. The computer program product of claim 11, wherein the program instructions are stored in a non-transitory computer readable storage medium in a data processing system, and wherein the program instructions were downloaded over a network from a remote data processing system.

15. The computer program product of claim 11, wherein the program instructions are stored in a non-transitory computer readable storage medium in a server data processing system, and wherein the program instructions are downloaded over a network to a remote data processing system for use in a non-transitory computer readable storage medium with the remote system.

16. The computer program product of claim 11, wherein the application is a first application and further comprising:
program instructions, stored on the non-transitory computer recordable storage medium, for receiving configuration information for a second application comprising a number of tasks that is performed by the second application and a number of parameters for performing each of the number of tasks; and
program instructions, stored on the non-transitory computer recordable storage medium, for adding the configuration information for the second application to a registry.

17. The computer program product of claim 12, wherein program instructions, stored on the non-transitory computer recordable storage medium, for identifying a number of applications that is configured to perform the task comprises:
program instructions, stored on the non-transitory computer recordable storage medium, for determining whether the identification of the second application includes the task to be performed;
program instructions, stored on the non-transitory computer recordable storage medium, for adding the second application to the number of applications responsive to a determination that the identification of the second application includes the task to be performed.

18. An apparatus comprising:
a bus system;
a storage device connected to the bus system, wherein the storage device includes program code; and
a processor unit connected to the bus system, wherein the processor unit processes the program code to:
identify in a registry a number of applications that is configured to perform a task responsive to receiving the search request comprising the task to be performed;
identify a set of parameters in the search request;
determine whether an application in the number of applications is configured to receive a parameter to perform the task that is absent from the set of parameters identified in the search request;
present a request for the parameter responsive to a determination that the application in the number of applications is configured to receive the parameter to perform the task that is absent from the search request; and
present the number of applications that is configured to perform the task.

19. The apparatus of claim 18, wherein the processor unit processing the program code to perform the task comprises:
the processor unit further processing the program code to identify a number of tasks configured to be performed by the application in the number of applications using configuration information; and identify a number of parameters that the application is configured to receive to perform the number of tasks.

20. The apparatus of claim 19, wherein the configuration information comprises an extensible markup language file.
